(19) United States
(12) Patent Application Publication
(10) Pub. No.: US 2016/0192618 A1
(43) Pub. Date: Jul. 7, 2016

(54) Animal Retaining Livestock Chute Device

(71) Applicant: Harvard Punt, Hull, IA (US)

(72) Inventor: Harvard Punt, Hull, IA (US)

(21) Appl. No.: 14/591,122

(22) Filed: Jan. 7, 2015

(51) Int. Cl. A01K 1/06

(52) U.S. Cl. CPC A01K 1/0613

(57) ABSTRACT

An animal retaining livestock chute device suspends lateral retaining panels over a ground surface to prevent fouling of the device during use. The device includes a frame elongated between a first end and a second end. Each of the first end and the second end is open for livestock to pass through the frame. A first lateral panel has an upper end coupled to the frame and a bottom end free and positioned in spaced relationship to a bottom of the frame. A second lateral panel is positioned opposite the first lateral panel wherein the first lateral panel and the second lateral panel define a path through the frame between the first end and the second end. The first lateral panel is movable laterally towards the second lateral panel for engaging and restraining an animal in the path.

### BACKGROUND OF THE DISCLOSURE

### Field of the Disclosure

The disclosure relates to livestock chute devices and more particularly pertains to a new livestock chute device for suspending lateral retaining panels over a ground surface to prevent fouling of the device during use.

### SUMMARY OF THE DISCLOSURE

An embodiment of the disclosure meets the needs presented above by generally comprising a frame elongated between a first end and a second end. Each of the first end and the second end is open for livestock to pass through the frame. A first lateral panel has an upper end coupled to the frame and a bottom end free and positioned in spaced relationship to a bottom of the frame. A second lateral panel is positioned opposite the first lateral panel wherein the first lateral panel and the second lateral panel define a path through the frame between the first end and the second end. The first lateral panel is movable laterally towards the second lateral panel for engaging and restraining an animal in the path.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a animal retaining livestock chute device according to an embodiment of the disclosure.

FIG. 2 is a detailed front view of an embodiment of the disclosure.

FIG. 3 is a front view of a head gate of an embodiment of the disclosure.

FIG. 4 is a detailed view of a post assembly of an embodiment of the disclosure.

FIG. 5 is a partial interior view of a frame of an embodiment of the disclosure with the first and second lateral panels in an expanded position.

FIG. 6 is a partial interior view of a frame of an embodiment of the disclosure with the first and second lateral panels in a contracted position.

### DESCRIPTION OF THE PREFERRED EMBODIMENT

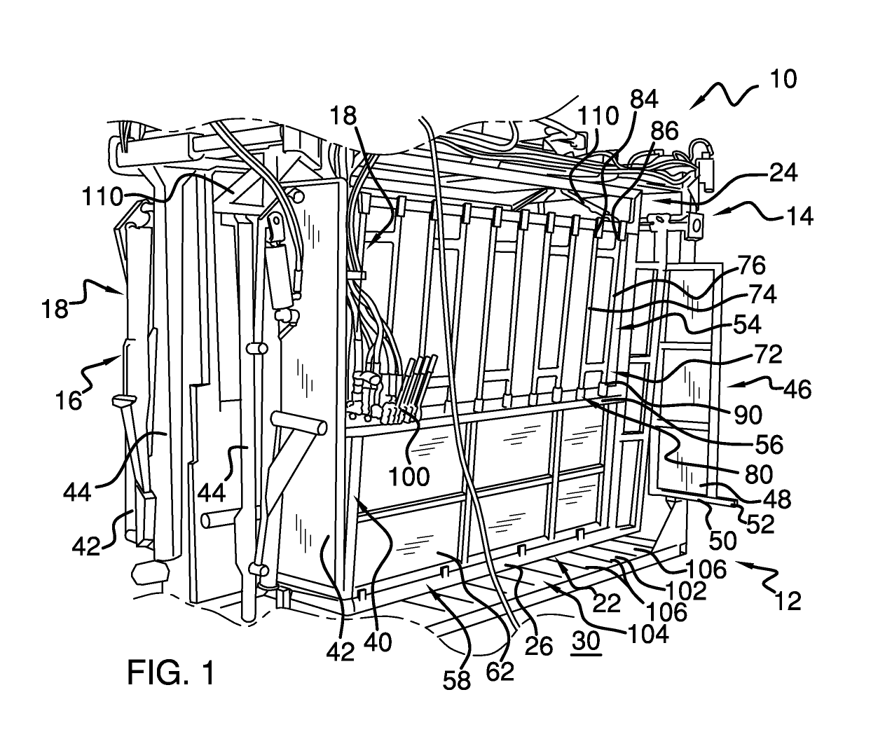

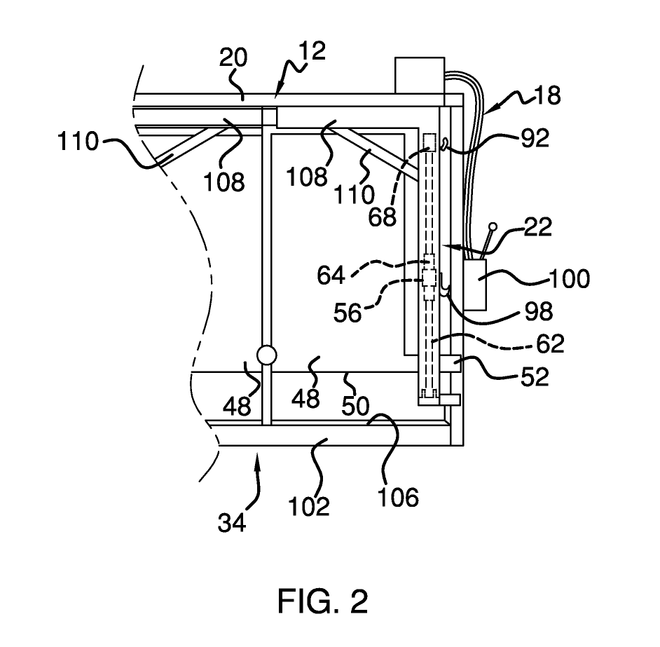

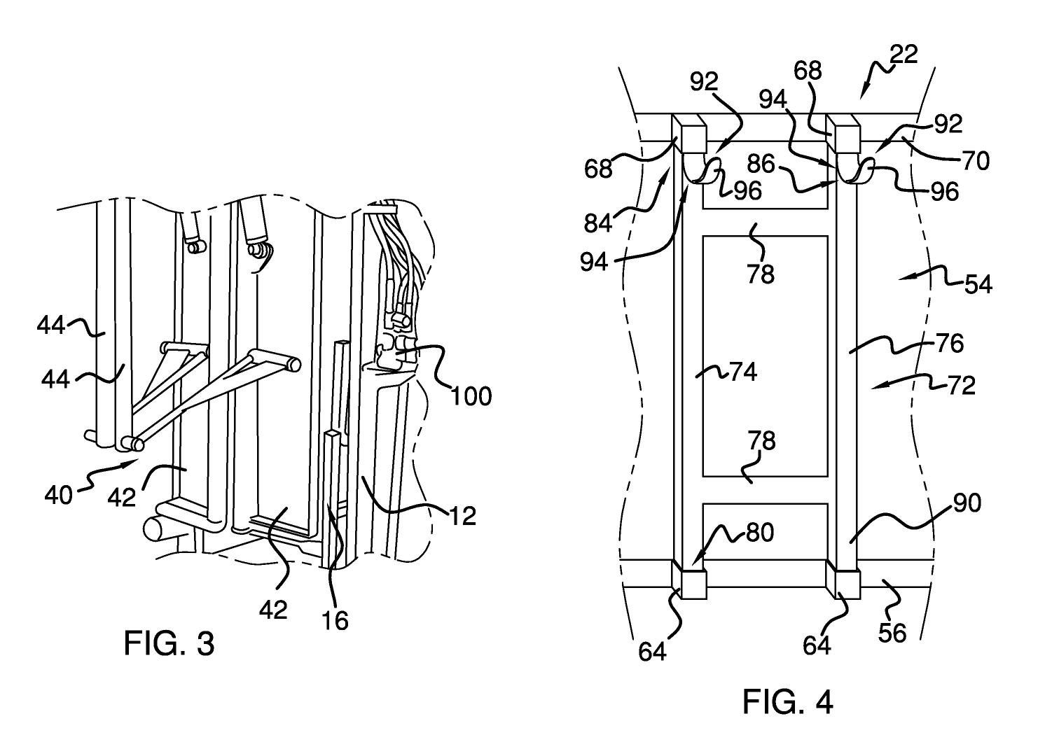

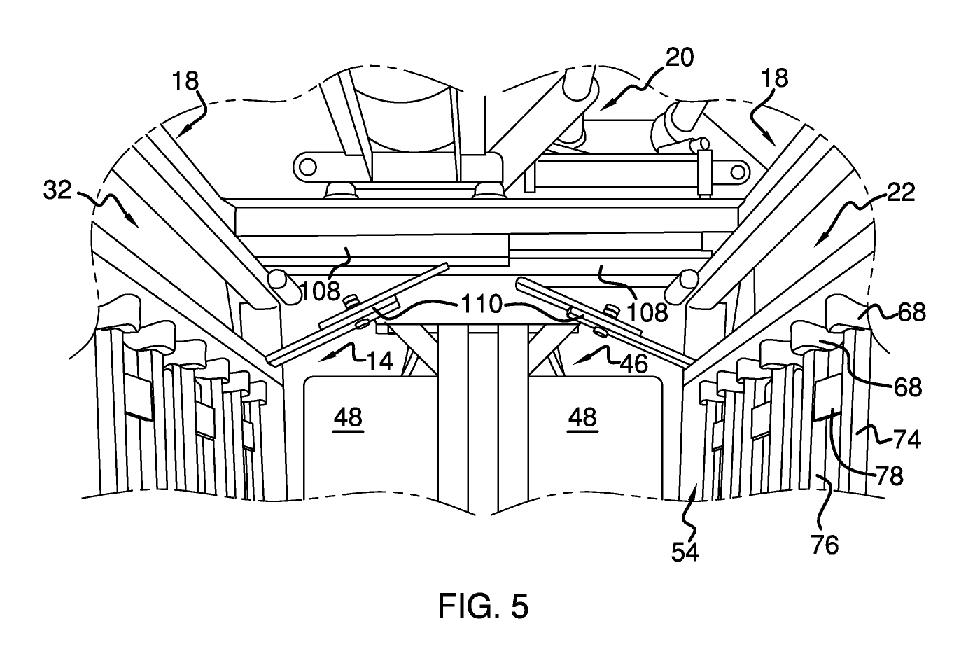

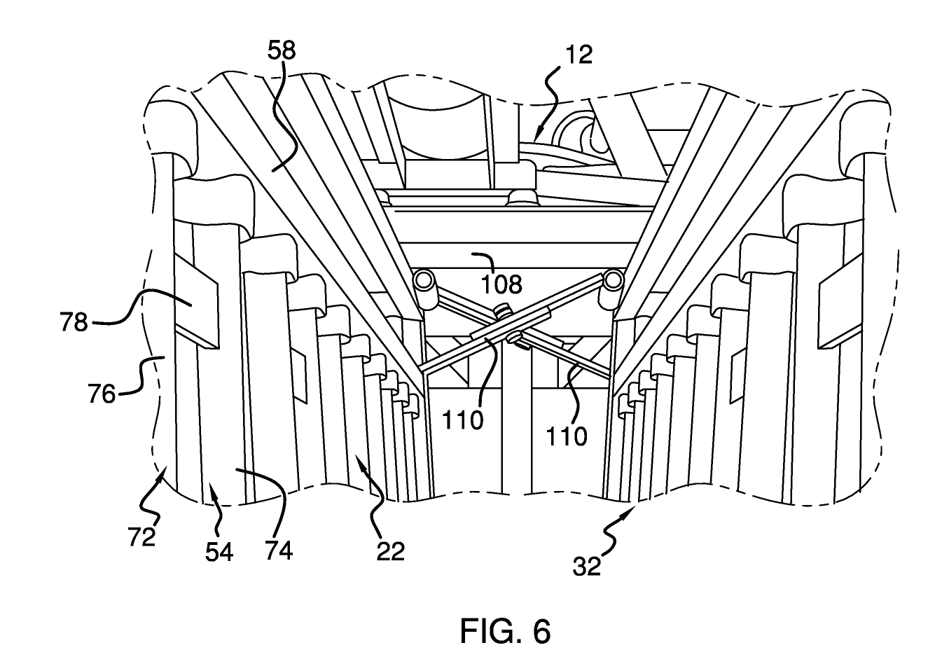

With reference now to the drawings, and in particular to FIGS. 1 through 6 thereof, a new livestock chute device embodying the principles and concepts of an embodiment of the disclosure and generally designated by the reference numeral 10 will be described.

As best illustrated in FIGS. 1 through 6, the animal retaining livestock chute device 10 generally comprises a frame 12 having a first end 14, a second end 16, and lateral sides 18 extending between the first end 14 and the second end 16. The frame 12 has a top 20 extending between the first end 14 and the second end 16. The frame 12 is elongated between the first end 14 and the second end 16. Each of the first end 14 and the second end 16 is open such that the frame 12 is configured for livestock to pass under the top 20 of the frame 12 by entering the first end 14 and exiting the second end 16. A first lateral panel 22 is coupled to the frame 12. The first lateral panel 22 has an upper end 24 coupled to the frame 12. A bottom end 26 of the first lateral panel 22 is free and unattached directly to the frame 12 wherein the bottom end 26 is prevented from being positioned where any dirt, soil, excrement, or other substances collect. Thus, the first lateral panel 22 is designed to remain clear of those substances which may foul a tongue in groove or other type of physical connection if the bottom end 26 were connected directly to the frame 12 in some manner. The bottom end 26 is positioned in spaced relationship to a bottom 28 of the frame 12 wherein the bottom end 26 of the first lateral panel 22 is configured to be positioned in spaced relationship over a ground surface 30 supporting the frame 12. A floor 102 is coupled to said frame 12. The floor 102 has a solid continuous upper surface 104 wherein the floor 102 is configured for covering the ground surface 30 under the frame 12. Each of a plurality of ridges 106 is coupled to and extends laterally across the floor 102 to enhance traction on the floor 102.

A second lateral panel 32 is coupled to the frame 12. The second lateral panel 32 is positioned opposite the first lateral panel 22 wherein the first lateral panel 22 and the second lateral panel 32 define a path 34 under the top 20 of the frame 12 between the first end 14 of the frame 12 and the second end 16 of the frame 12. The second lateral panel 32 may be a structural mirror image of the first lateral panel 22 to be movable in a sliding motion towards the first lateral panel 22. The second lateral panel 32 has an upper end 36 coupled to the frame 12 and a bottom end 38 of the second lateral panel 32 is free and positioned in spaced relationship to the bottom 28 of the frame 12 wherein the bottom end 38 of the second lateral panel 32 is also configured to be and remain positioned in spaced relationship over the ground surface 30 supporting the frame 12. The second lateral panel 32 is movably coupled to the frame 12 such that the second lateral panel 32 moves laterally towards the first lateral panel 22 when the first lateral panel 22 is moved towards the second lateral panel 32. The first lateral panel 22 and the second lateral panel 24 may be mechanically coupled in a conventional manner to provide movement which is coordinated and maintains even spacing on either side of a center of the path 34. The first lateral panel 22 is movably coupled to the frame 12 such that the first lateral panel 22 moves laterally in a sliding motion towards a second lateral panel 32. Thus, the first lateral panel 22 and the second lateral panel 32 are configured for engaging and restraining an animal in the path 34. The first lateral panel 22 and the second lateral panel 32 may each include a respective sleeve 108 adjacent to each of the first end 14 and the second end 16 of the frame and coupled to a top of the respective panel 22,32. Each sleeve 108 is secured by a respective brace 110.

A head gate 40 is coupled to the second end 16 of the frame 12. The head gate 40 has a pair of doors 42 positioned to move inwardly from the lateral sides 18 of the frame 12 such that the doors 42 are configured to abut the animal adjacent shoulders of the animal to inhibit the animal from passing fully through the second end 16 of the frame 12. Each of a pair of uprights 44 is coupled to an associated one of the doors 42. The uprights 44 are extendable away from the doors 42 such that the uprights 44 are configured for engaging a head of the animal to extend the head of the animal away from the doors 42 to restrict movement of the neck of the animal. The uprights move simultaneously outwardly and upwardly relative to the doors 42. The uprights 44 remain parallel to the doors 42 as the uprights 44 are moved relative to the doors 42.

A rear gate 46 is coupled to the first end 14 of the frame 12. The rear gate 46 selectively covers the first end 14 of the frame 12 such that the rear gate 46 is configured for preventing the animal from backing out of the path 34 through the first end 14 of the frame 12. The rear gate 46 may comprise a pair of sliding panels 48. Each sliding panel 48 has a free lower end 50 and an extension 52 which is positioned adjacent to the frame 12 when the rear gate 46 is in a closed position to inhibit the panels 48 from moving outwardly relative to the first end 14 of the frame 12.

The first lateral panel 22 more specifically has an open top section 54 defined by a medial beam 56 coupled to and extending across a periphery 58 of the first lateral panel 22. Each of a plurality of sockets 64 is coupled to the first lateral panel 22. Each of the sockets 64 is coupled to the first lateral panel 22 along a bottom edge 66 of the open top section 54. Each of a plurality of receivers 68 is coupled to the first lateral panel 22.

Each of the receivers 68 is positioned along a top edge 70 of the open top section 54. Each of the receivers 68 is vertically aligned over an associated one of the sockets 64. Each of a plurality of posts assemblies 72 comprises a main post 74 and a secondary post 76. The main post 74 is coupled to the secondary post 76 by a pair of spacers 78 extending between the main post 74 and the secondary post 76. A lower end 80 of each main post 74 is insertable into a selectable one of the sockets 64 and an upper end 84 of the main post 74 is insertable into the vertically aligned receiver 68 wherein the post assembly 72 is coupled to the first lateral panel 22 and pivotable about the main post 74. An upper end 86 of the secondary post 76 of each post assembly 72 is also couplable to one of the receivers 68 adjacent to the receiver 68 receiving the upper end 84 of the main post 74 of the post assembly 72. Thus, each post assembly 72 is positionable in the open top section 54 such that the post assembly 72 is coplanar with the first lateral panel 22. The main post 74 of each post assembly 72 is parallel to the secondary post 76. The upper end 84 of the main post 74 of each post assembly 72 is laterally aligned with the upper end 86 of the secondary post 76 of the post assembly 72. The main post 74 of each post assembly 72 has a length greater than a length of the secondary post 76 of the post assembly 72 such that a lower end 90 of the secondary post 76 is positioned over but does not engage an adjacently positioned one of the sockets 64.

Each of a plurality of retainers 92 is coupled to an associated one of the receivers 68. Each retainer 92 has a flat portion 94 facing the associated retainer 68 such that the flat section 94 abuts the upper end 84 of the main post 74 or the upper end 86 of the secondary post 86 when the respective upper end 84,86 is positioned in the associated receiver 68. Thusly, the retainer 92 inhibits the respective upper end 84,86 from being removed from the associated receiver 68. Each retainer 92 has a sloped face 96 positioned to face outwardly from the first lateral panel 22. Each retainer 92 is slidably coupled to the first lateral panel 22 such that pressure on the sloped face 96 urges the retainer 92 upwardly into an open position allowing for insertion of the respective upper end 84,86 into the associated receiver 68. Each retainer 92 may be manually grasped and moved upwardly to release the respective upper end 84,86 from the associated receiver 68. Thus, one or more post assemblies 72 may be arranged and positioned as desired, installed or removed while the animal is being held between the first lateral panel 22 and the second lateral panel 34.

The medial beam 56 also defines an open bottom section 60 in the first lateral panel 22. The open bottom section 60 of the first lateral panel 22 may be closed by positioning of a solid continuous plate 62 positioned in the bottom section 60. The plate 62 may be removable if desired. The plate 62 may also be secured and released using retainers 98 having structure similar or identical to the retainers 92 described above.

Although the first lateral panel 22 has been described in detail, the second lateral panel 32 is similarly structured to the first lateral panel 22 as described above. A hydraulic system 100 may be attached to the frame 12 and mechanically coupled to each of the structural elements described above for movement of the doors 42, the uprights 44, the first lateral panel 22, the second lateral panel 32, and the rear gate 46.

In use, the device 10 is positioned in a desired location for bringing livestock into the first end 14 of the frame 12. The animal is secured in the frame 12 by movement of the head gate 40, the rear gate 46, the first lateral panel 22, and second lateral panel 32 as desired. The animal may be inspected, medicated, treated or the like while restrained. The post assemblies 42 may be manipulated to enhance access to the animal. The animal may be released and another animal subsequently restrained in like fashion. The device 10 remains free of fouling near the ground surface 30 as there are no moving parts, channels, or the like provided in which debris, excrement, or the like can accumulate to inhibit movement of the working parts of the device 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An animal retaining livestock chute device comprising:
a frame having a first end, a second end, and lateral sides extending between said first end and said second end, said frame having a top extending between said first end and said second end, said frame being elongated between said first end and said second end, each of said first end and said second end being open such that said frame is configured for livestock to pass under said top of said frame by entering said first end and exiting said second end;
a first lateral panel coupled to said frame, said first lateral panel having an upper end coupled to said frame, a bottom end of said first lateral panel being free and positioned in spaced relationship to a bottom of said frame wherein said bottom end of said first lateral panel is configured to be positioned in spaced relationship over a ground surface supporting said frame;
a second lateral panel coupled to said frame, said second lateral panel being positioned opposite said first lateral panel wherein said first lateral panel and said second lateral panel define a path under said top of said frame between said first end of said frame and said second end of said frame; and
wherein said first lateral panel is movably coupled to said frame such that said first lateral panel moves laterally towards said second lateral panel wherein said first lateral panel and said second lateral panel are configured for engaging and restraining an animal in said path.

2. The device of claim 1, further comprising said second lateral panel having an upper end coupled to said frame, a bottom end of said second lateral panel being free and positioned in spaced relationship to said bottom of said frame wherein said bottom end of said second lateral panel is configured to be positioned in spaced relationship over the ground surface supporting said frame.

3. The device of claim 2, further comprising said second lateral panel being movably coupled to said frame such that said second lateral panel moves laterally towards said first lateral panel when said first lateral panel is moved towards said second lateral panel.

4. The device of claim 1, further comprising a head gate coupled to said second end of said frame, said head gate having a pair of doors positioned to move inwardly from said lateral sides of said frame such that said doors are configured to abut the animal adjacent shoulders of the animal to inhibit the animal from passing fully through said second end of said frame.

5. The device of claim 4, further comprising a pair of uprights, each upright being coupled to an associated one of said doors, said uprights being extendable away from said doors such that said uprights are configured for engaging a head of the animal to extend the head of the animal away from said doors to restrict movement of the neck of the animal.

6. The device of claim 5, further comprising said uprights moving simultaneously outwardly and upwardly relative to said doors.

7. The device of claim 5, further comprising said uprights remaining parallel to said doors as said uprights are moved relative to said doors.

8. The device of claim 1, further comprising a rear gate coupled to said first end of said frame, said rear gate selectively covering said first end of said frame such that said rear gate wherein said rear gate is configured for preventing the animal from backing out of said path through said first end of said frame.

9. The device of claim 1, further comprising said first lateral panel having an open top section.

10. The device of claim 9, further comprising:
a plurality of sockets coupled to said first lateral panel, each of said sockets being coupled to said first lateral panel along a bottom edge of said open top section;
a plurality of receivers coupled to said first lateral panel, each of said receivers being positioned along a top edge of said open top section; and
a plurality of posts assemblies, each said post assembly comprising a main post and a secondary post, said main post being coupled to said secondary post by a pair of spacers extending between said main post and said secondary post, a lower end of each said main post being insertable into a selectable one of said sockets and an upper end of said main post being insertable into said vertically aligned receiver wherein said post assembly is pivotable about said main post.

11. The device of claim 10, further comprising an upper end of said secondary post of each said post assembly being couplable to one of said receivers adjacent to said receiver receiving said upper end of said main post of said post assembly wherein each said post assembly is positionable in said open top section such that said post assembly is coplanar with said first lateral panel.

12. The device of claim 10, further comprising said main post of each said post assembly being parallel to said secondary post, said upper end of said main post of each said post assembly being laterally aligned with said upper end of said secondary post of said post assembly, said main post of each said post assembly having a length greater than a length of said secondary post of said post assembly.

13. The device of claim 10, further comprising each of said receivers being vertically aligned over an associated one of said sockets.

14. The device of claim 10, further comprising a plurality of retainers, each said retainer being coupled to an associated one of said receivers, each said retainer having a flat portion facing said associated retainer such that said flat section abuts an upper end of said post when said upper end of said post is positioned in said associated receiver whereby said retainer inhibits said upper end of said post from being removed from said associated receiver.

15. The device of claim 14, further comprising each said retainer having a sloped face positioned to face outwardly from said first lateral panel, each said retainer being slidably coupled to said first lateral panel such that pressure on said sloped face urges said retainer upwardly into an open position allowing for insertion of said post assembly into said associated receiver.

16. The device of claim 1, further comprising said open top section being defined by a medial beam coupled to and extending across a peripheral, said medial beam defining an open bottom section in said first lateral panel.

17. The device of claim 16, further comprising said open bottom section of said first lateral panel being closed by a plate positioned in said bottom section.

18. The device of claim 1, further comprising a floor coupled to said frame, said floor having a solid continuous upper surface wherein said floor is configured for covering the ground surface under said frame.

19. The device of claim 18, further comprising a plurality of ridges coupled to and extending laterally across said floor.

20. An animal retaining livestock chute device comprising:
a frame having a first end, a second end, and lateral sides extending between said first end and said second end, said frame having a top extending between said first end and said second end, said frame being elongated between said first end and said second end, each of said first end and said second end being open such that said frame is configured for livestock to pass under said top of said frame by entering said first end and exiting said second end;
a first lateral panel coupled to said frame, said first lateral panel having an upper end coupled to said frame, a bottom end of said first lateral panel being free and positioned in spaced relationship to a bottom of said frame wherein said bottom end of said first lateral panel is configured to be positioned in spaced relationship over a ground surface supporting said frame;
a second lateral panel coupled to said frame, said second lateral panel being positioned opposite said first lateral panel wherein said first lateral panel and said second lateral panel define a path under said top of said frame between said first end of said frame and said second end of said frame, said second lateral panel having an upper end coupled to said frame, a bottom end of said second lateral panel being free and positioned in spaced relationship to said bottom of said frame wherein said bottom end of said second lateral panel is configured to be positioned in spaced relationship over the ground surface supporting said frame, said second lateral panel being movably coupled to said frame such that said second lateral panel moves laterally towards said first lateral panel when said first lateral panel is moved towards said second lateral panel;
wherein said first lateral panel is movably coupled to said frame such that said first lateral panel moves laterally towards said second lateral panel wherein said first lateral panel and said second lateral panel are configured for engaging and restraining an animal in said path.
a head gate coupled to said second end of said frame, said head gate having a pair of doors positioned to move inwardly from said lateral sides of said frame such that said doors are configured to abut the animal adjacent shoulders of the animal to inhibit the animal from passing fully through said second end of said frame;
a pair of uprights, each upright being coupled to an associated one of said doors, said uprights being extendable away from said doors such that said uprights are configured for engaging a head of the animal to extend the head of the animal away from said doors to restrict movement of the neck of the animal, said uprights moving simultaneously outwardly and upwardly relative to said doors, said uprights remaining parallel to said doors as said uprights are moved relative to said doors;
a rear gate coupled to said first end of said frame, said rear gate selectively covering said first end of said frame such that said rear gate wherein said rear gate is configured for preventing the animal from backing out of said path through said first end of said frame;
said first lateral panel having an open top section, said open top section being defined by a medial beam coupled to and extending across a peripheral, said medial beam defining an open bottom section in said first lateral panel, said open bottom section of said first lateral panel being closed by a plate positioned in said bottom section;
a plurality of sockets coupled to said first lateral panel, each of said sockets being coupled to said first lateral panel along a bottom edge of said open top section;
a plurality of receivers coupled to said first lateral panel, each of said receivers being positioned along a top edge of said open top section, each of said receivers being vertically aligned over an associated one of said sockets;
a plurality of posts assemblies, each said post assembly comprising a main post and a secondary post, said main post being coupled to said secondary post by a pair of spacers extending between said main post and said secondary post, a lower end of each said main post being insertable into a selectable one of said sockets and an upper end of said main post being insertable into said vertically aligned receiver wherein said post assembly is pivotable about said main post, an upper end of said secondary post of each said post assembly being couplable to one of said receivers adjacent to said receiver receiving said upper end of said main post of said post assembly wherein each said post assembly is positionable in said open top section such that said post assembly is coplanar with said first lateral panel, said main post of each said post assembly being parallel to said secondary post, said upper end of said main post of each said post assembly being laterally aligned with said upper end of said secondary post of said post assembly, said main post of each said post assembly having a length greater than a length of said secondary post of said post assembly.
a plurality of retainers, each said retainer being coupled to an associated one of said receivers, each said retainer having a flat portion facing said associated retainer such that said flat section abuts an upper end of said post when said upper end of said post is positioned in said associated receiver whereby said retainer inhibits said upper end of said post from being removed from said associated receiver, each said retainer having a sloped face positioned to face outwardly from said first lateral panel, each said retainer being slidably coupled to said first lateral panel such that pressure on said sloped face urges said retainer upwardly into an open position allowing for insertion of said post assembly into said associated receiver;
a floor coupled to said frame, said floor having a solid continuous upper surface wherein said floor is configured for covering the ground surface under said frame; and
a plurality of ridges coupled to and extending laterally across said floor.
